(19) United States
(12) Patent Application Publication
(10) Pub. No.: US 2009/0032352 A1
(43) Pub. Date: Feb. 5, 2009

(54) Motor actuated range shift and on demand 4wd

(75) Inventors: Larry A. Pritchard, Macomb, MI (US); Christopher J. Kowalsky, Windsor (CA)

Correspondence Address: WARN, HOFFMANN, MILLER & LALONE, .P.C, PO BOX 70098, ROCHESTER HILLS, MI, 48307, US

(73) Assignee: BorgWarner Inc., Auburn Hills, MI (US)

(21) Appl. No.: 12/221,389

(22) Filed: Aug. 1, 2008

Related U.S. Application Data
(60) Provisional application No. 60/963,046, filed on Aug. 2, 2007.

(51) Int. Cl. B60W 10/02; B60W 10/10

(52) U.S. Cl. 192/3.52; 192/3.61; 192/3.56

(57) ABSTRACT

The present invention is a transfer case incorporating the use of a single actuator having an input member selectively engagable to a primary output member, an actuator operatively associated with a clutch assembly and a range selector, a first one-way clutch operably associated with the actuator, and a second one-way clutch operably associated with the actuator. When the actuator is actuated in a first direction, the first one-way clutch will activate the range selector to couple the input member and the primary output member to have either of a direct drive ratio, or a reduced gear ratio. When the actuator is actuated in a second direction, the actuator will actuate the second one-way clutch to engage the clutch assembly, transferring rotational force from the primary output member to a secondary output member.

### CROSS-REFERENCE TO RELATED APPLICATIONS

This application claims the benefit of U.S. Provisional Application No. 60/963,046, filed Aug. 2, 2007. The disclosure of the above application is incorporated herein by reference.

### FIELD OF THE INVENTION

The present invention relates to a transfer case having brushless motor technology to perform both range shift and mode selection functions.

### BACKGROUND OF THE INVENTION

Transfer cases are commonly used in vehicles which incorporate the use of four-wheel drive capability. Typically, the transfer case is connected to the vehicle transmission, and has the ability to selectively deliver power to a secondary set of wheels. The transmission will normally deliver power through the transfer case to a primary set of wheels, unless additional power is required, or it is desired to have power delivered to the secondary set of wheels under adverse driving conditions.

Most transfer cases utilize a type of actuator which has a clutch pack to selectively engage a secondary output shaft which would deliver power to the secondary set of wheels upon compression of the clutch pack. The clutch pack can be fully compressed or partially compressed to allow for slip to occur through the clutch, delivering a reduced amount of power to the secondary set of wheels. These transfer cases also have a second actuator which is used for performing the range shift functions. Most transfer cases have the capability to incorporate transferring power from the transmission through the transfer case at a 1:1, or direct gear ratio, as well as a reduced gear ratio, in which the power output, or torque amplification through the transfer case, is anywhere from 2.5:1 to 4:1. Transfer cases often incorporate this type of capability for use in various driving conditions where low speed and high torque output characteristics are desirable.

One way to activate the clutch pack is to use what is commonly known as a “ball ramp assembly,” which usually consists of a base plate having a series of recesses for supporting a set of load transferring members, and a cam plate in contact with the clutch pack, which also has a series of recesses for supporting the load transferring members. When the base plate and the cam plate rotate relative to one another, they will separate and the distance between them will increase, and force is applied to the clutch pack by the cam plate. Many transfer cases incorporate the use of an electromagnetic clutch to activate the ball ramp assembly. If an electromagnetic clutch is used, the base plate and the cam plate will rotate about a common axis with the input shaft and output shaft of the transfer case. Once the electromagnetic clutch causes relative rotation between the cam plate and the base plate, the load transferring members will rotate in the recesses of the cam plate and the base plate, causing the cam plate to translate axially along the axis about which the shafts of the transfer case rotate, thereby applying force to the clutch pack.

The electromagnetic clutch and ball ramp assembly form an actuator for operating the clutch pack. The other actuator is used for performing the range shift functions, i.e., changing the operation of the transfer case from a direct drive, or 1:1 ratio, to a reduced gear ratio, such as 2.5:1 gear ratio.

Having one actuator to actuate the clutch pack, as well as a second actuator to perform the range shift functions, does not always facilitate meeting certain packaging requirements for the transfer case. Increased performance requirements, as well as reduced amount of available space in vehicles which have increased technology and reduced size, can limit the amount of space available for the use of two actuators in a single transfer case.

Accordingly, there exists a need for a single actuator to perform both the range shift functions, actuating the clutch pack, as well as the mode shift functions of a transfer case. There also exists a need for a single actuator to meet various packaging requirements, where a limited amount of space is available.

### SUMMARY OF THE INVENTION

The present invention is a transfer case incorporating the use of a single actuator having an input member selectively engagable to a primary output member, an actuator operatively associated with a clutch assembly and a range selector, a first one-way clutch operably associated with the actuator, and a second one-way clutch operably associated with the actuator.

When the actuator is actuated in a first direction, the first one-way clutch will activate the range selector to couple the input member and the primary output member to have either of a direct drive ratio, or a reduced gear ratio. When the actuator is actuated in a second direction, the actuator will actuate the second one-way clutch to activate a ball ramp mechanism thereby engaging the clutch assembly, transferring rotational force from the primary output member to a secondary output member.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a schematic of a transfer case, according to the present invention;

FIG. 2 is a sectional side view of a transfer case incorporating brushless motor technology to perform both the range shift and mode selection functions, according to the present invention;

FIG. 3a is a front view of a base plate having a series of cams, used in a transfer case incorporating brushless motor technology, according to the present invention;

FIG. 3b is a front view of a cam plate having a series of cams, used in a transfer case incorporating brushless motor technology, according to the present invention;

FIG. 4 is a sectional front view taken along line 4-4 of FIG. 2, of a transfer case incorporating brushless motor technology, according to the present invention;

FIG. 5 is a sectional front view taken along line 5-5 of FIG. 1, of a transfer case incorporating brushless motor technology, according to the present invention; and

FIG. 6 is an alternate embodiment of a transfer case incorporating brushless motor technology as shown in FIG. 5, with a portion of the coil windings removed, according to the present invention.

### DETAILED DESCRIPTION OF THE PREFERRED EMBODIMENTS

The following description of the preferred embodiment(s) is merely exemplary in nature and is in no way intended to limit the invention, its application, or uses.

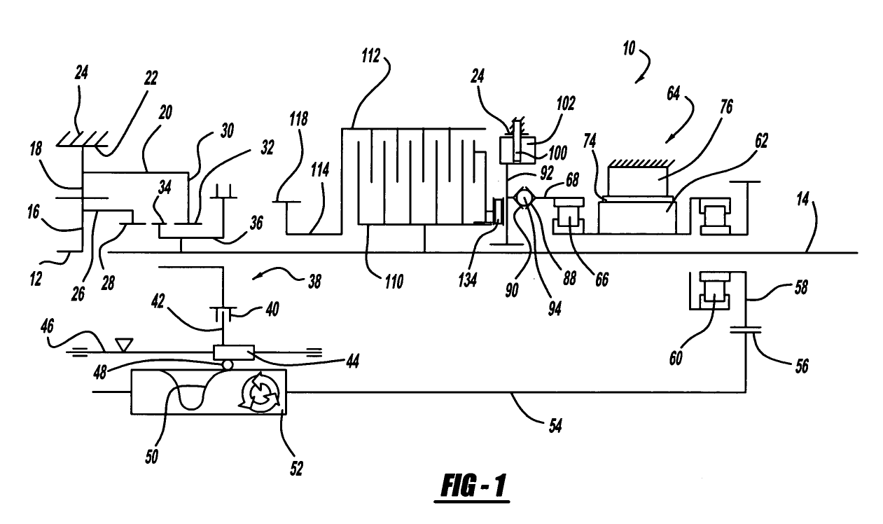

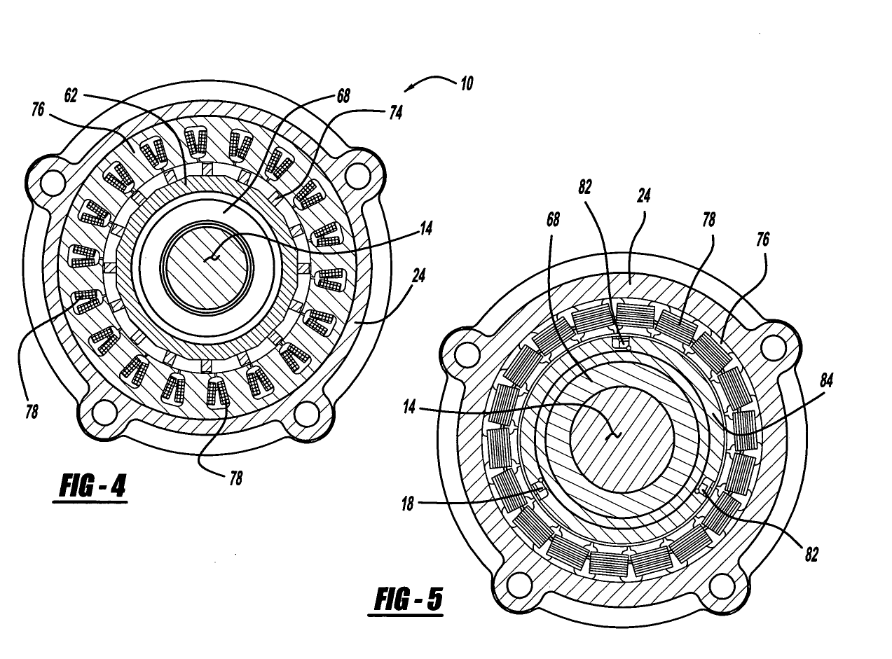

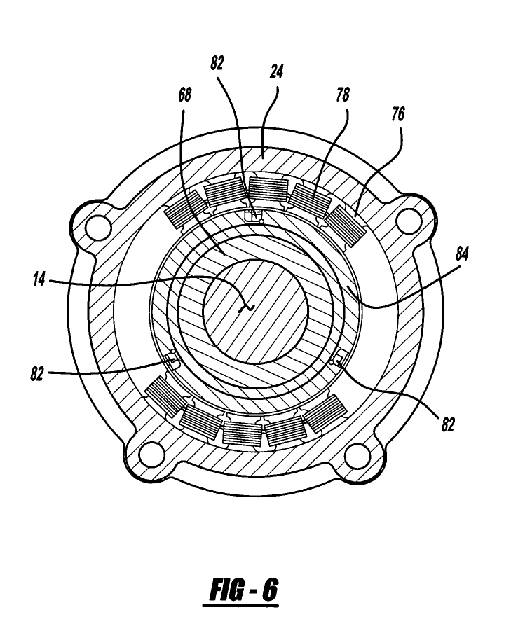

A schematic of a transfer case incorporating a single actuator having brushless motor technology for performing the range shift and mode selection functions in a transfer case according to the present invention is generally shown in FIG. 1 at 10. Referring to FIGS. 1-5 generally, the transfer case 10 includes an input member 12 selectably connected to a primary output member 14. Connected to the input member 12 is a sun gear 16, which is in mesh with a series of planetary gears 18. The planetary gears 18 are mounted on a carrier 20, and are free to rotate thereon. The planetary gears 18 are also in mesh with a ring gear 22 which is fixed to the housing 24 of the transfer case 10.

Also connected to the sun gear 16 is an extension 26 having a first set of teeth 28, and connected to the carrier 20 is another extension 30 having a second set of teeth 32. The first set of teeth 28 and the second set of teeth 32 are selectively engagable for a spline connection with a set of main teeth 34 mounted on a shift rail 36. The shift rail 36 forms part of a dog clutch, generally shown at 38. The dog clutch 38 also includes a shift collar 40 which receives a shift fork 42. The shift fork 42 is connected to a sliding member 44. The sliding member 44 is slidably mounted on a live range shift shaft 46, and includes a lobe 48 which is received by a cam 50 on a unidirectional shift cam 52. The unidirectional shift cam 52 is mounted on a shaft 54, which is connected to a first output gear 56. The shift rail 36, dog clutch 38, shift fork 42, sliding member 44, shift shaft 46, and the unidirectional shift cam 52 form a range selector.

The output gear 56 is in mesh with a gear 58 connected to the inner diameter of a first drive member in the form of a first one-way clutch 60. The outer diameter of the first one-way clutch 60 is connected to a rotor 62 which is part of an actuator in the form of a brushless motor, generally shown at 64, having brushless motor technology. The rotor 62 is also connected to the inner diameter of a second drive member in the form of a second one-way clutch 66. The outer diameter of the second one-way clutch 66 is connected to a base plate 68.

The primary output member 14 extends through, and is freely able to rotate within the brushless motor 64 due to a pair of needle bearings 70,72. The brushless motor 64 also has a magnet rotor 74 connected to the rotor 62. Surrounding the magnet rotor 74 is a stator 76 having a series of coil windings 78; the stator 76 is connected to the housing 24 of the transfer case 10. The magnet rotor 74 includes a magnet 80 which is used along with a sensor 82 to detect the position of the magnet rotor 74 relative to the housing 24. The sensor 82 is part of a sensor plate 84 which is attached to the housing 24 through a set of fasteners 86.

The rotor 62, magnet rotor 74, stator 76, and coil windings 78 are all typical components used in a conventional brushless motor, and form an actuator used to rotate the first one-way clutch 60 and second one-way clutch 66.

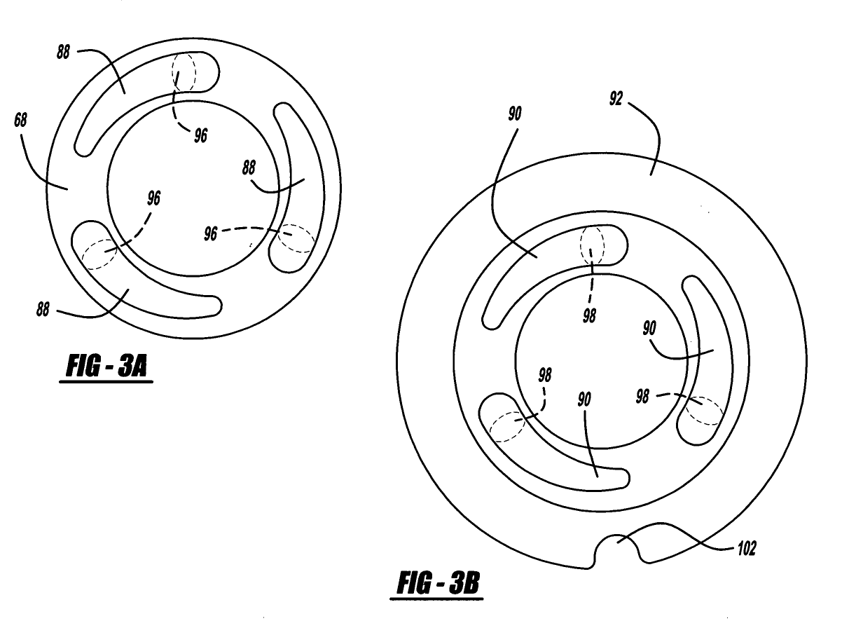

The base plate 68 has at least one cam, but more preferably a first series of cams 88 which are used with at least one cam, but more preferably a second series of cams 90 located in a cam plate 92 for supporting at least one load transferring member, which in this embodiment is a set of load transferring balls 94. The base plate 68, cam plate 92, and the load transferring balls 94 form a ball ramp assembly. In an alternate embodiment, the first series of cams 88 include a first set of detents 96 (shown in phantom) which are used along with a series of corresponding second set of detents 98 (also shown in phantom) in the second series of cams 90 to hold the load transferring balls 94 in a stationary position when the magnet rotor 74 is not actuated. The cam plate 92 is restricted from rotating relative to the housing 24 by the use of a projection 100. The projection 100 extends into an anti-rotation feature 102 (shown in FIG. 3B) which restricts the cam plate 92 from rotating about an axis 104, but allows the cam plate 92 to translate along the axis 104.

The shaft 14 also has a set of splines 106 which are complementary to a set of splines 108 on an extension 110. A clutch housing 112 is part of a clutch assembly, and partially surrounds the extension 110, and includes a base portion 114, and is allowed to rotate relative to the extension 110 and the primary output member 14 by way of a thrust bearing 116 underneath the base portion 114. A similar thrust bearing 116 supports the gear 58, between the gear 58 and the output member 14. The base portion 114 supports a gear 118, the function of which will be described later. The clutch housing 112 is used for receiving a clutch pack 120, which is also part of the clutch assembly. The clutch pack 120 is a typical clutch pack having a first series of clutch plates 122 connected to the clutch housing 112 through a spline connection 124, interleaved with a second series of clutch plates 126 connected to the extension 110 through a spline connection 128. The clutch pack 120 is selectively compressed by the ball ramp assembly.

The extension 110 also supports an apply plate 130 which is able to slide along the outside of the extension 110 through the use of a spline connection 132. The apply plate 130 is allowed to rotate relative to the cam plate 92 while still having the ability to receive force from the cam plate 92 because of a thrust bearing 134. The clutch pack 120 is compressed by the apply plate 130, the function of which will be described later. The clutch housing 112 also includes a set of splines. The set of splines 136 are disposed within the clutch housing 112 and are used for supporting the first series of clutch plates 122.

The input member 12, output member 14, rotor 62, base plate 68, and apply plate 130 all rotate about the axis 104.

In operation, the input member 12 receives power from a transmission. The power transferred to the input member 12 transfers through the input member 12 to the sun gear 16, and causes the planetary gears 18 to rotate. If the main teeth 34 on the shift rail 36 are engaged with the first set of teeth 28 on the extension 26, the rotational force from the sun gear 16 will be transferred directly to the output member 14 through the extension 26, the first set of teeth 28, the main teeth 34, the shift rail 36, and then to the output member 14. This will cause the input member 12 and output member 14 to rotate at a direct or 1:1 ratio.

If the main teeth 34 are configured to be engaged with the second set of teeth 32 on the extension 30 of the carrier 20, the rotational force from the sun gear 16 will transfer through the planetary gears 18, causing the carrier 20 to rotate. Because of the planetary gears 18, the carrier will rotate at a predetermined reduced speed as compared to the input member 12, depending upon the gear ratio between the sun gear 16 and planetary gears 18. This reduced ratio increases the torque transferred from the input member 12 to the output member 14. The reduced ratio can be typically from 2.5:1, to 4:1. In this configuration the rotational force will be transferred from the input member 12, the sun gear 16, the planetary gears 18, the carrier 20, to the extension 30, the second set of teeth 32, the main teeth 34, to the shift rail 36, and then to the output shaft 14. Operating the transfer case 10 at the reduced gear ratio increases the amount of rotational force, or torque, transferred from the input member 12 to the output member 14. The output member 14 is connected to a drive shaft, which is typically connected to a differential having a set of wheels. As the output member 14 rotates, the rotational force will be transferred from the drive shaft to the primary set of wheels, causing the vehicle to move.

Actuation of the dog clutch 38 to change the operation of the transfer case 10 from a direct drive ratio to a reduced gear ratio is accomplished by power being applied to the coil winding 78 in a first direction. This will cause the magnet rotor 74 and the rotor 62 to rotate in a first direction. When the rotor 62 rotates in the first direction, rotational force is transferred through the first one way clutch 60, and to the gear 58. As the gear 58 rotates, the first output gear 56 will rotate as well. As the first output gear 56 rotates, the shaft 54 will also rotate, rotating the unidirectional shift cam 52. As the unidirectional shift cam 52 rotates, the lobe 48 will move in the cam surface 50, translating the sliding member 44 along the live range shift shaft 46. As the sliding member 44 moves, the shift fork 42 will translate the shift rail 36 along the output member 14. As the shift rail 36 moves along the live range shift shaft 46, the shift rail 36 will slide towards the first set of teeth 28 or the second set of teeth 32.

If it is desired to have the shift rail move towards the second set of teeth 32, the unidirectional shift cam 52 can be rotated in a single direction such that as the unidirectional shift cam 52 rotates, the cam surface 50 will cause the lobe 48 to translate the shift rail 36 towards the second set of teeth 32. Because of the shape of the camming surface 50, the unidirectional shift cam 52 can be rotated continuously in one direction to translate the sliding member 44 along the live range shift shaft 46 in two directions. This will cause the shift fork 42 to translate the shift rail 36 in two directions along the output member 14, allowing the main teeth 34 to be engaged with either the first set of teeth 28 or the second set of teeth 32, or a neutral position in which the main teeth 34 are located in between the first set of teeth 28 and the second set of teeth 32, as shown in FIG. 1.

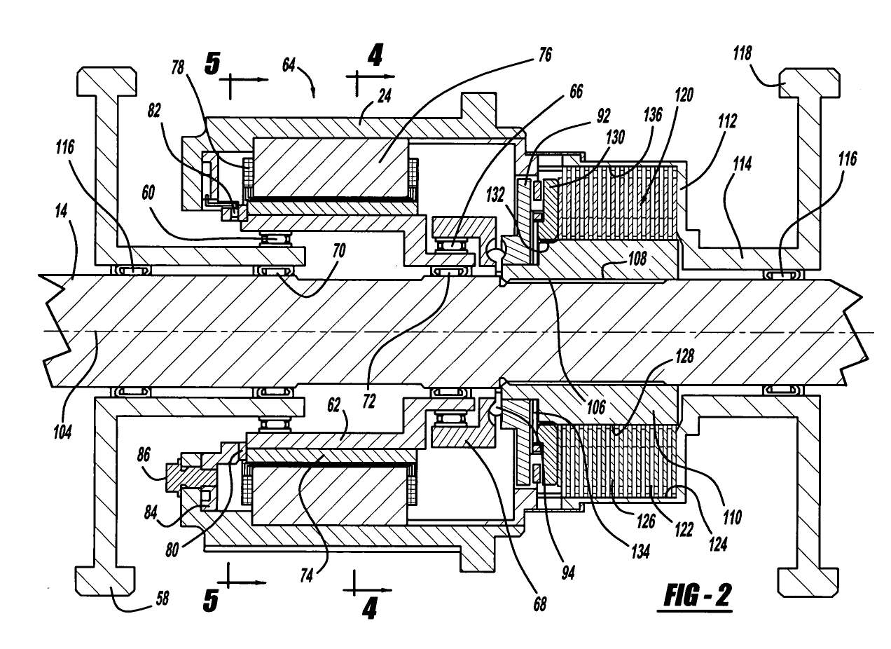

If it is desired to deliver power to all four wheels of the vehicle, power can be applied to the coil winding 78 such that the magnet rotor 74 and the rotor 62 will rotate in a second direction relative to the transfer case housing 24 which is the opposite of the first direction. Once the rotor 62 begins to rotate in the second direction, the second one-way clutch 66 will cause the base plate 68 to rotate. Once the base plate 68 begins to rotate, the load transferring balls 94 will roll in the first and second series of cams 88,90. This will cause the cam plate 92 and the base plate 68 to move apart, and the cam plate 92 to move toward, and apply force, to the thrust bearing 134. The cam plate 92 will only be allowed to slide to the left or right when looking at FIG. 2, the cam plate 92 is not allowed to rotate because of the projection 100. This force is transferred through to the apply plate 130, compressing the clutch pack 120. If the first and second detents 96,98 are used, then the force of rotation by the base plate 68 must overcome the force of the first and second detents 96,98, holding the load transferring balls 94 in place. Once the load transferring balls 94 roll out of the first and second detents 96,98 as stated above, the base plate 68 and the cam plate 92 will move away from one another; the cam plate 92 will begin to move toward, and apply force to, the thrust bearing 134.

Once the clutch pack 120 is fully compressed, the output member 14 will rotate in unison with the clutch pack 120. This rotational force will be transferred through the clutch pack to the base portion 114, and to the gear 118. The gear 118 is typically partially circumscribed by a chain (not shown) which transfers the rotational force received by the gear 118 to another gear (not shown) which is connected to a secondary output member. The secondary output member is typically connected to a secondary set of wheels which can selectively receive the driving force from the engine and transmission from the transfer case 10.

However, if it is desired to transfer a reduced amount of rotational force from the input member 12 to the base portion 114 and therefore the gear 118, the electric current applied to the coil winding 78 can be reduced, and the amount of rotation by the rotor 62, and therefore the base plate 68 and the magnet rotor 74, will be reduced as well. The distance the cam plate 92 will move toward the thrust bearing 134 is based on the rotation of the base plate 68. Varying the amount of current applied to the coil windings 78 will vary the amount of rotation of the base plate 68, and therefore vary the distance the cam plate 92 will translate towards the thrust bearing 134, thereby varying the amount of force applied to the clutch pack 120.

The amount of rotation of the magnet rotor 74, the rotor 62, and the base plate 68 about the axis 104 is measured by the magnet 80 and the sensor 82. The output of the sensor 82 and the amount of current applied to the coil winding 78 can be controlled by a common electronic control unit (not shown). Other sensors could be used instead of the sensor 82, such as a sensor for sensing the position of the base plate 68, the cam plate 92, or load sensor for detecting the load applied to the clutch pack 120.

It should be noted that the purpose of the first one-way clutch 60 and the second one-way clutch 66 is to allow the compression of the clutch pack 120, as well as the activation of the dog clutch 38, to be actuated independently of one another. When the rotor 62 rotates in the first direction to actuate the first one-way clutch 60, to perform the range shift selections with the dog clutch 38, the second one-way clutch 66 will free wheel and the clutch pack 120 will not be compressed. Once the rotor 62 is actuated in the second direction to rotate the second one-way clutch 66, the first one-way clutch 60 will free wheel, and the range shift selector will remain in the selected mode.

Another embodiment of the present invention is shown in FIG. 6. This embodiment is similar to the embodiment shown in FIGS. 1-5, however, a portion of the coil windings 78 have been removed. The amount of coil windings 78 used can vary, depending upon the application in which the transfer case 10 is going to be used. More windings 78 can produce a greater rotational force, and therefore a greater apply load to the clutch pack 120. The embodiment shown in FIG. 6 includes five coil windings 78 on each side of the magnet rotor 78, but it is within the scope of the invention that more or less windings 78 may be used.

Also, since the rotor 62, magnet rotor 74, and stator 76 are concentrically mounted about the primary output member 14, less space is occupied in the transfer case 10, presenting an advantage in packaging over other transfer cases using conventional actuation methods.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A transfer case comprising:
an input member selectively engagable to a primary output member;
an actuator operably associated with a clutch assembly and a range selector;
a first drive member operably associated with said actuator;
a second drive member operably associated with said actuator; and
when said actuator is actuated in a first direction, said first drive member will activate said range selector to couple said input member and said primary output member to have either of a direct drive ratio or a reduced gear ratio, and when said actuator is actuated in a second direction, said actuator will actuate said second drive member to engage said clutch assembly, transferring rotational force from said primary output member to a secondary output member.

2. The transfer case of claim 1, wherein said first drive member further comprises a first one-way clutch, and said second drive member further comprises a second one-way clutch.

3. The transfer case of claim 1, said actuator further comprising:
a base plate disposed about an axis;
a cam plate disposed about said axis;
at least one cam, operably associated with said base plate and said cam plate;
at least one load transferring member operably associated with said at least one cam; and
when said actuator is rotated in said first direction, said first drive member will rotate said base plate, causing said at least one load transferring member to move with respect to said at least one cam, and said cam plate to translate along said axis, actuating said clutch assembly.

4. The transfer case of claim 3, said actuator further comprising:
a stator mounted to a housing, said stator having a plurality of coil windings;
a magnet rotor circumscribing a rotor, said magnet rotor and said rotor rotatable about said axis;
said rotor operably associated with said first drive member and said second drive member; and
when a current is applied to said plurality of coil windings, said magnet rotor and said rotor will rotate in either of said first direction or said second direction.

5. The transfer case of claim 3, said clutch assembly further comprising:
a clutch pack having a first series of clutch plates interleaved with a second series of clutch plates;
a clutch housing connected to said second series of clutch plates, said clutch housing operably connected to at least one gear;
an extension operably associated with said output member, said extension in spline connection with and supporting said first series of clutch plates; and
wherein said base plate rotates, and said cam plate translates along said axis, said clutch pack will become compressed, causing said input member to transfer rotational force to said at least one gear.

6. The transfer case of claim 1, said range selector further comprising:
a shaft having a unidirectional shift cam, said unidirectional shift cam rotatably supported by said shaft;
a cam formed in a portion of said unidirectional shift cam;
a lobe connected to a sliding member rotatably mounted on a live range shift shaft, a portion of said lobe received in said cam of said unidirectional shift cam;
a shift fork connected to said sliding member, said shift fork operably associated with a shift rail, said shift rail slidably disposed on said primary output member; and
as said unidirectional shift cam is rotated, said cam will move said lobe and said sliding member on said live range shift shaft, moving said shift rail and said shift fork to cause said shift fork to selectively engage said input member to said primary output member to provide either of said direct drive ratio, or a reduced gear ratio.

7. The transfer case of claim 6, wherein said unidirectional shift cam is actuated by said first drive member.

8. The transfer case of claim 6, further comprising:
a sun gear connected to input member, said sun gear in mesh with at least one planetary gear, and said at least one planetary gear connected to a carrier;
a ring gear surrounding and in mesh with said at least one planetary gear;
a first set of teeth connected to an extension on said sun gear;
a second set of teeth connected to an extension said carrier; and
wherein said unidirectional shift cam is rotated, causing said shift rail to engage either one of said first set of teeth providing said direct gear ratio, or said second set of teeth providing said reduced gear ratio.

9. The transfer case of claim 8, when said main teeth are engaged with said first set of teeth, rotational force will be transferred from said primary input member to said sun gear, from said first set of teeth to said main teeth, to said shift rail, and to said primary output member, providing said direct gear ratio.

10. The transfer case of claim 8, when said main teeth are engaged with said second set of teeth, rotational force will be transferred from said primary input member to said sun gear, to said planetary gears, to said carrier, to said second set of teeth, said main teeth, to said shift rail, and to said primary output member, providing said reduced gear ratio.

11. The transfer case of claim 1, when said first drive member is actuated by said actuator, said second drive member will not be actuated, and when said second drive member is actuated by said actuator, said first drive member will not be actuated.

12. A transfer case having a single actuator, comprising:
an actuator having a stator with coil windings mounted to a housing, said stator surrounding a magnet rotor, said magnet rotor surrounding a rotor, said magnet rotor and said rotor rotatable about an axis;
a first one-way clutch operably associated with said rotor and a range selector, said range selector operably associated with an input member and a primary output member;
a second one-way clutch operably associated with said rotor and a clutch assembly, said clutch assembly operably associated with said primary output member and a secondary output member; and
when a current is applied to said coil windings, said rotor will rotate in a first direction, actuating said first one-way clutch and said range selector, and when said rotor is actuated in a second direction, said rotor will actuate said second one-way clutch and said clutch assembly.

13. The transfer case of claim 12, said actuator further comprising:
a base plate operably associated with said second one-way clutch;
a cam plate operably associated with said base plate, and said clutch assembly;
at least one load transferring member disposed between said base plate and said cam plate; and
wherein said rotor rotates in said second direction, actuating said second one-way clutch, said base plate will rotate about said axis, causing said at least one load transferring member to translate said cam plate along said axis, actuating said clutch assembly.

14. The transfer case of claim 12, said clutch assembly further comprising:
a first series of clutch plates interleaved with a second series of clutch plates, said first series of clutch plates connected to a clutch housing;
an extension connected to said second series of clutch plates, said extension operably associated with said secondary output member; and
wherein said cam plate translates along said axis, said cam plate will compress said first series of clutch plates and said second series of clutch plates, causing said extension to transfer rotational force through said second series of clutch plates, through said first series of clutch plates and through said housing, thereby transferring rotational force to said secondary output member.

15. The transfer case of claim 12, said range selector further comprising:
a dog clutch having a shift rail including a set of main teeth and a shift fork operably associated with said shift rail, said shift rail slidably mounted on said primary output member;
a live range shift shaft for supporting a sliding member having at least one lobe;
a unidirectional shift cam having a cam, said cam operably associated with said at least one lobe;
a shaft for supporting said unidirectional shift cam, said shaft operably associated with said first one-way clutch; and
wherein said rotor actuates said first one-way clutch, said first one-way clutch will rotate said shaft, said unidirectional shift cam will rotate to cause said at least one lobe to move on said cam, causing said sliding member to move on said live range shift shaft, and said shift fork to move said shift rail on said primary output member, selecting one of a direct drive ratio between said input member and said primary output member, or a reduced gear ratio between said input member and said primary output member.

16. The transfer case of claim 15, further comprising:
a sun gear connected to an input member, a set of planetary gears in mesh with said sun gear, said set of planetary gears operably connected to a carrier having an extension;
a first set of teeth connected to an extension on said sun gear;
a ring gear in mesh with said set of planetary gears;
a second set of teeth connected to said extension of said carrier; and
said rotor is actuated in a first direction, actuating said first one-way clutch, causing said one-way clutch to rotate said unidirectional shift cam, and said lobe to move in said camming surface, causing said sliding member to slide along said live range shift shaft and said shift rail to engage said main teeth with either of said first set of teeth or said second set of teeth;
when said main teeth are engaged with said first set of teeth, rotational force is transferred from said input member through said sun gear, said first set of teeth, said main teeth, said shift rail, and to said primary output member to produce said direct drive ratio; and
when said main teeth are engaged with said second set of teeth, rotational force is transferred from said input member through said sun gear, said set of planetary gears, said carrier, said extension, said second set of teeth, said main teeth, said shift rail, and to said primary output member, producing said reduced gear ratio.

17. The transfer case of claim 12, when said first one-way clutch is activated by said rotor, said second one-way clutch will free wheel, and when said second one-way clutch is activated by said rotor, said first one-way clutch will free wheel.

18. A transfer case having a single actuator for performing both range shift and mode functions, comprising:
an input member;
a range selector for selectively connecting said input member and a primary output member, said range selector having a unidirectional shift cam operably associated with a first one-way clutch, said unidirectional shift cam having a cam for receiving a lobe on a sliding member, said sliding member mounted on a live range shift shaft, a shift fork connected to said sliding member, said shift fork partially received within a shift collar of a shift rail, said shift rail having a set of main teeth;
an actuator having a stator including a plurality of coil windings, a magnet rotor surrounding a rotor, said rotor connected to said first one-way clutch and a second one-way clutch;
a clutch assembly having a first series of clutch plates interleaved with a second series of clutch plates, said first series of clutch plates connected to a clutch housing, and said second series of clutch plates connected to an extension mounted on said primary output member, said clutch assembly operably associated with a secondary output member;
when said rotor is rotated in a first direction, said rotor will actuate said first one-way clutch causing said unidirectional shift cam to rotate, and said at least one lobe to move along said cam to move said sliding member along said live range shift shaft, causing said shift fork to move said shift rail along said primary output member to engage said input member and have a direct drive ratio or a reduced gear ratio; and
when said rotor is rotated in a second direction, said second one-way clutch will be activated, compressing said first series of clutch plates and said second series of clutch plates, causing said primary output member to transfer rotational force from said extension, through said second series of clutch plates, said first series of clutch plates, through said housing, and to said secondary output member.

19. The transfer case having a single actuator for performing both range shift and mode functions of claim 18, further comprising:
a sun gear having an extension with a first set of teeth, said first set of teeth selectively engageable with said main teeth, said sun gear in mesh with a set of planetary gears;
a ring gear circumscribing and in mesh with said planetary gears, said ring gear connected to a housing;
a carrier for supporting said set of planetary gears, said carrier having an extension and a second set of teeth selectively engageable with said main teeth; and
when said main teeth of said shift rail are engaged with said first set of teeth, said input member will transfer rotational force through said sun gear to said extension of said sun gear to said first set of teeth, to said main teeth, said shift rail, and to said primary output shaft to produce a direct drive ratio, and when said main teeth of said shift rail are engaged with said second set of teeth, said input member will transfer rotational force through said sun gear, said set of planetary gears, said carrier and said extension of said carrier to said second set of teeth, said main teeth, to said shift rail and to said primary output member, producing a reduced gear ratio.

20. The transfer case having a single actuator for performing both range shift and mode functions of claim 18, further comprising:
a base plate for partially receiving a series of load transferring members, said base plate connected to said second one-way clutch;
a cam plate for partially receiving said series of load transferring members, said cam plate operably associated with said second set of clutch plates, and said extension; and
when said rotor rotates said second one-way clutch, said second one-way clutch will rotate said base plate, causing said series of load transferring members to translate said cam plate along said axis, applying force to said second series of clutch plates, compressing said first series of clutch plates and said second series of clutch plates, transferring rotational force from said primary output member to a secondary output member.

21. The transfer case having a single actuator for performing both range shift and mode functions of claim 18, when said rotor rotates in a first direction to actuate said first one-way clutch, said second one-way clutch will not be actuated, and when said rotor rotates in a second direction to actuate said second one-way clutch, said first one-way clutch will not be actuated.
